(19) United States
(12) Patent Application Publication
(10) Pub. No.: US 2008/0082407 A1
(43) Pub. Date: Apr. 3, 2008

(54) Rewarding Good Consumer Credit Card Behavior

(75) Inventors: Margaret H. Georgiadis, Kenilworth, IL (US); Anas Osman, Glenview, IL (US); Kelly J. Tufts, Wilmette, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: DISCOVER FINANCIAL SERVICES LLC, Riverwoods, IL (US)

(21) Appl. No.: 11/532,152

(22) Filed: Sep. 15, 2006

(51) Int. Cl. G06Q 30/00; G06Q 40/00

(52) U.S. Cl. 705/14; 705/38

(57) ABSTRACT

Systems and methods are described whereby credit card customers can receive predictable rewards that serve as incentives to manage their credit card debt payments wisely. In particular, credit card holders receive rewards when making several consecutive timely payments. Cardholders also receive rewards when, in a given timeframe, they make some predetermined number of payments above the amount of the minimum payment due. The rewards may be processed in any of several ways chosen by the customer. The rewards' value may be arbitrary (dynamic or static), or based on account variables, such as the amount of interest due on the credit card account.

### FIELD OF THE INVENTION

This invention pertains generally to the field of consumer financial management and more particularly to providing rewards for good consumer credit behavior.

### BACKGROUND OF THE INVENTION

As credit cards, debit cards, and other alternatives to currency have grown in popularity, the competition among the institutions that provide these financial instruments has also increased. Today, many consumers choose a credit card, debit card, or the like, based on the financial incentive to the consumer for using such a card. Some popular incentives offered are points, miles, cash or other rewards. Typically, such rewards have been awarded by the card issuer based on purchase transactions made with the card: for every transaction made by a cardholder using, say, a credit card, a proportional number of points, miles or other rewards may be placed into a separate account. When a sufficient amount of rewards have accumulated in the account, the consumer may be able to redeem them for goods, services, or discounts toward the purchase of same.

While these reward programs indeed give consumers incentives to use particular credit cards for their purchases, they do not necessarily promote healthy financial behavior in general. For example, most existing reward programs that are based entirely on consumer purchases do nothing to encourage consumers to pay their credit card bills on time, or to pay above the minimum amount due. As a result, some consumers may make purchases using a credit card simply to receive a program's reward, even though they carry large balances on their card, where the corresponding finance charges for the purchases exceed the rewards' actual value. These consumers may be earning the card issuers' rewards while their credit scores are actually dropping.

Additionally, traditional reward systems have been limited by the extent to which rewards could be redeemed. For example, rewards in the form of airline miles may be limited to redemption only for travel, and only on a particular airline. Similarly, loyalty points rewarded by a particular retail store may be limited to redemption only at that store. These limited options often require some additional purchase to be made, and cannot be used in more general ways that may be more helpful to a consumer's financial management goals.

A few attempts have been made to address the aforementioned problems. For example, in U.S. Pat. Publication No. 2003/0105689 to Chandak et al., a system is described for rewarding a cardholder with consumer goods when a timely payment is received. Chandak, however, does not give the cardholder any incentive to maintain a habit of making timely payments, as the rewards are based only on individual payments on the account, and do not consider previous cardholder behavior.

In U.S. Pat. Publication No. 2006/0031158 to Orman, a system is described for rewarding cardholders when their credit scores increase. Credit scores, however, are generally not calculated by the card issuer and, more importantly, are not easily available or predictable to the cardholders. A cardholder may be unaware of how, or the extent to which, his particular behavior may affect his credit score. Furthermore, credit scores often involve factors not determined by individual behavior. For example, an individual's credit score may be computed relative to a population, rather than based solely on the individual's behavior. Thus, an individual who makes several timely payments above the minimum amount due may nevertheless suffer a decrease in credit score if the relative population has similarly engaged in such good practices.

A system is needed that provides customers with predictable rewards that can be easily redeemed and that serve as incentives to manage their credit card debt payments wisely.

### BRIEF SUMMARY OF THE INVENTION

The invention provides customers with predictable rewards that serve as incentives to manage their credit card debt payments wisely. In particular, credit card holders receive rewards when making several consecutive timely payments. Cardholders also receive rewards when, in a given timeframe, they make some predetermined number of payments above the minimum payment due.

In one embodiment, a method is provided for providing rewards to a customer of a financial institution, the customer maintaining an account with the financial institution for a revolving line of credit, payments on the account due at about regular intervals in an amount of at least a minimum payment amount due for each interval, the method comprising receiving a number of consecutive timely payments for consecutive intervals, each payment of at least for the minimum amount due on the account, determining that the number of consecutive timely payments is equal to or greater than a predetermined threshold greater than one, and in response to the determining step, providing rewards to the customer.

In another embodiment, a method is provided for providing rewards to a customer of a financial institution, the customer maintaining an account with the financial institution for a revolving line of credit, payments on the account due at about regular periodic intervals in an amount of at least a minimum payment for each period, the method comprising receiving a number of payments within a predetermined timeframe, each of the payments being of a value exceeding the minimum amount due for the corresponding period, determining that the number of payments exceeding the minimum amount due is equal to or greater than a predetermined threshold greater than one, and in response to the determining step, providing rewards to the customer.

In still another embodiment, a system is provided for providing rewards to a customer of a financial institution, the system comprising a billing module for preparing a billing statement at a substantially regular periodic interval to be sent to a customer of the financial institution, the customer maintaining an account with the financial institution for a line of credit, and the statement indicating the status of the account, and a payment-based rewards determination module for determining that the customer has satisfied one or more predetermined payment criteria, and for determining the number or amount of rewards to be rewarded to the customer for satisfying the one or more predetermined payment criteria with the rewards amount calculated off of a dynamic variable, such as the periodic finance charges assessed or a static amount, such as a flat amount, i.e. $20.

### BRIEF DESCRIPTION OF THE SEVERAL VIEWS OF THE DRAWING(S)

While the appended claims set forth the features of the present invention with particularity, the invention and its advantages are best understood from the following detailed description taken in conjunction with the accompanying drawings, of which:

FIG. 1 is a general overview of the operation of a method and system contemplated by an embodiment of the present invention;

FIG. 2 is a flow diagram illustrating details of a method of providing rewards for timely credit card payments, in accordance with an embodiment of the invention;

FIG. 3 is a chart illustrating an exemplary application of a method for providing rewards for timely credit card payments, in accordance with an embodiment of the invention;

FIG. 4 is a flow diagram illustrating details of a method of providing rewards for above-minimum credit card payments, in accordance with an embodiment of the invention; and

FIG. 5 is a diagram illustrating options for processing rewards earned by a credit card holder, in accordance with an embodiment of the invention.

### DETAILED DESCRIPTION OF THE INVENTION

For simplicity, the description that follows will be provided by reference to a specific type of financial alternative to currency known in the art as a “credit card”. However, as will be clear to those skilled in the art, no aspect of the present invention is specifically limited to credit card applications. Therefore, it is intended that the following description also encompass the use of the present invention with many other forms of debt products, including lines of credit, loans, mortgages, installment plans, and the like.

Similarly, while the description that follows will, for simplicity, be provided by reference to a specific type of award (or “reward”), known in the art as a “cash rebate” reward, it is not intended to limit the use of the present invention to award systems dealing only with cash rebate rewards. For example, the present invention can be applied to award programs offering points, miles, coupons, credits, discounts, refunds, and the like.

A financial institution providing alternatives to currency, such as credit cards, generally receives income from at least two sources: (1) the merchant, who remits to the financial institution a fee that is customarily a small fixed transaction fee plus a percentage of the purchase price of an item purchased by a consumer using the financial institution's credit card and (2) the consumer, who pays finance charges on unpaid balances that are generally, for consumer purchases, at a rate in excess of the prime rate of interest. Therefore, to increase income, a financial institution offering credit cards generally seeks to increase the total number of transactions and the total value of goods purchased by consumers using that institution's credit cards, which directly increases the income received from merchant fees and indirectly may increase the unpaid balance maintained by consumers, thereby increasing interest revenue. One common mechanism for increasing the total value of the goods purchased by consumers using the financial institution's credit cards is to offer an award, such as a cash rebate award, that is directly based on the total value of the goods purchased within a given time frame.

However, financial institutions also have a competing goal of ensuring their customers maintain their creditworthiness, and do not fall so far in debt that their risks of defaulting on their accounts increase. Financial institutions have historically worked toward this goal by limiting the amount of credit available to a customer, by requiring payments on a regular basis, and by requiring that payment be of some minimum value based on the balance of the account.

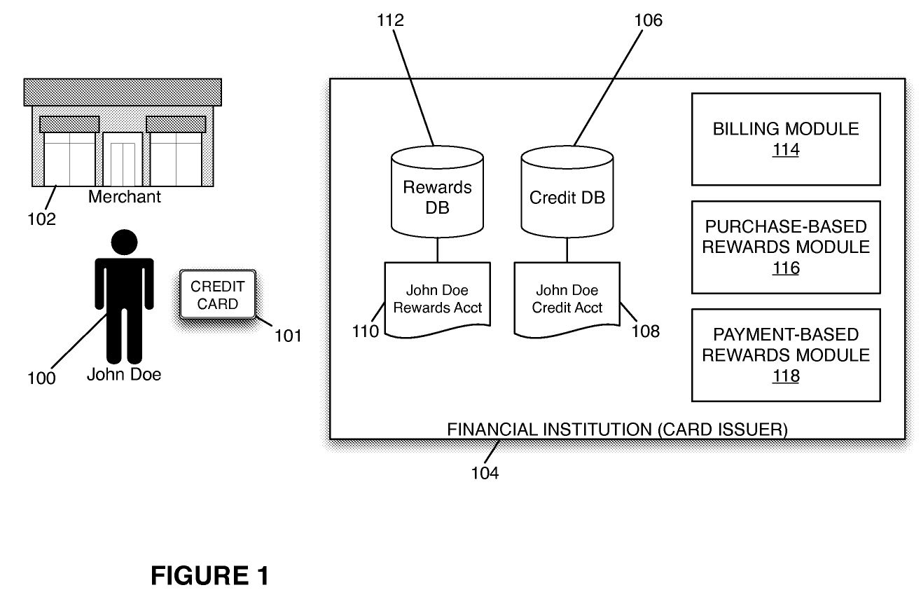

Turning to FIG. 1, an implementation of a good-credit rewards system contemplated by an embodiment of the present invention is shown with reference to an overall credit card usage environment. A consumer 100 can use a credit card 101 to purchase goods or services at any number of locations. An exemplary location illustrated in FIG. 1 is the merchant 102. Although the merchant 102 is depicted in FIG. 1 as brick-and-mortar stores, the merchant 102 need not be so limited in physical presence. For example, the merchant 102 could include a telephone-based retailer, a computer-based retailer operating a web site, a mail-order catalog retailer, or a merchant transacting business through some other medium. As will be known by those skilled in the art, the merchant may offer a variety of goods and services. For example, one of the merchant 102 can be a grocery store or mass-market retailer, or it can be a doctor's office or an accountant's office. Similarly, the merchant 102 can, for example, be an on-line retailer, or it can be an interface to private party transactions, such as through an auction web site.

Once the consumer 100 purchases goods or services, using a credit card 101, from the merchant 102, charge information is sent to a financial institution 104. Generally, financial institution 104 is the issuer of the credit card 101 being used by the consumer. The financial institution 104 can maintain a database, such as database 108 to record transactions performed by consumers using its issued cards. Information for a credit account 108 for the consumer 100 can be stored in the database 106. The issuer 104 also maintains information for the consumer's 100 accumulated rewards for using the credit card 101, in an account 110 stored in a rewards database 112. Alternatively, the rewards database 112 may be maintained by an outside entity (not shown) in communication with the issuer 104.

In an embodiment of the invention, the issuer 104 uses one or more preferably automated processes for managing billing and rewards for the consumer's 100 credit account 108 and rewards account 110 at some substantially regular interval, (e.g., monthly). The processes may be executed via hardware or software modules of one or more computing system operated by the issuer 104 or an agent of the issuer 104. A billing module 114 is used to prepare monthly statements by, for example, aggregating that month's transactions from the consumer's 100 credit account 108 and calculating finance charges (which may include, but are not limited to, any of interest charges, late fees, cash advance fees, check fees, balance transfer fees, or other charges) that may be due on the account 108. A purchase-based rewards module 116 is used to calculate a number and/or type of rewards that should be applied to the customer's 100 rewards account 110. The purchase-based rewards module 116 generally makes its calculations based on purchase transactions, as reflected in the customers' 100 credit account 108.

A payment-based rewards module 118 is used to determine whether rewards should be granted for a customer 100 based on preferably non-purchase transaction activity. For example, the payment-based rewards module 118 can determine how many consecutive payments on the credit account 108 have been timely made. If the number satisfies a predetermined policy, then rewards can be granted to the consumer 100. As another example, the payment-based rewards module 118 can annually determine the number of payments made during the year that were above the minimum due. If the number satisfies a predetermined policy, then rewards can be granted to the consumer 100. The rewards generated via the payment-based rewards module 118 are preferably in addition to any rewards generated from the purchase-based rewards module 116, and can be distributed in any number of ways, including by placement into the consumer's 100 rewards account 110. In some embodiments of the invention, the purchase-based rewards module 116 and the payment-based rewards module 118 are coextensive.

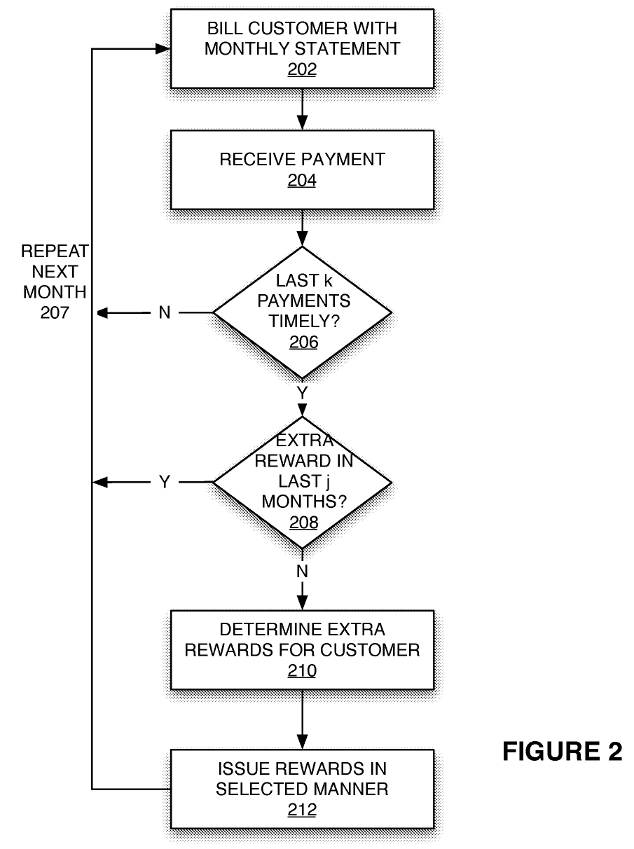

Turning to FIG. 2, a process is described for rewarding a credit card holder for making a series of timely payments, in accordance with an embodiment of the invention. Each month, the cardholder is billed at step 202, preferably with a statement containing the details of his credit account usage. Such usage can include balance information, a minimum amount presently due, a due date, transaction details for that month, finance charges, past payment information, year-to-date account information, rewards earning information, and the like. Although the process of FIG. 2 is described with respect to monthly intervals, other time intervals are possible for the billing cycle. Payment on the account is received at step 204. At step 206, it is determined whether the previous k payments have been timely received. The predetermined number k can be set to be any adequate number in accordance with a policy of the issuer and may, in various embodiments, be any integer from two to twelve or more. In one embodiment, the number k is at least three. In one embodiment, the number k is six. If not all of the last k payments were timely, then the account at step 207 can be checked again when preparing the next month's bill. Additionally, in some embodiments of the invention, it is also determined if the last k payments were at least of the minimum amount due.

If the last k payments were timely (and if they were at least of the minimum amount due), then it is determined at step 208 whether the cardholder has received any extra rewards for making timely payments within the previous j months. If so, the account can be checked again the next month at step 207. This extra checking can be done in order to comply with any predetermined policy of the issuer. For example, if the issuer has decided to limit the availability of extra rewards to twice during a year, the account can be checked again for consecutive timely payments in an additional six months. If no extra rewards have been given in the previous j months, then extra rewards are determined for the cardholder at step 210. In one embodiment, the amount of extra rewards is equivalent to the finance charges for that month. In another embodiment, the amount of extra rewards is equivalent to the finance charges for the next month. In this way, the cardholder can apply the extra rewards to his account balance and avoid having that month's finance charges capitalize. In some embodiments, the amount of rewards that can be applied against a cardholder's finance charges are quantized amounts (e.g., multiples of $20).

The rewards are issued at step 212 in any of a number of ways. In embodiments of the invention, these ways include, but are not limited to, applying the rewards to the account as a payment, accumulating the rewards in the cardholder's rewards account, generating a check that is delivered to the cardholder, making an electronic deposit to a cardholder's bank account or delivering a gift card or gift certificate to the cardholder that can be redeemed at a merchant. In the last instance, the merchant may participate in a partner arrangement with the issuer so that the gift card or gift certificate is worth additional funds than the rewards earned by the cardholder (e.g., double value). The cardholder can select the manner of processing either at that time, or he may previously have set up a default manner. Additionally, the issuer may process the rewards in a default manner if the cardholder has not made any selection.

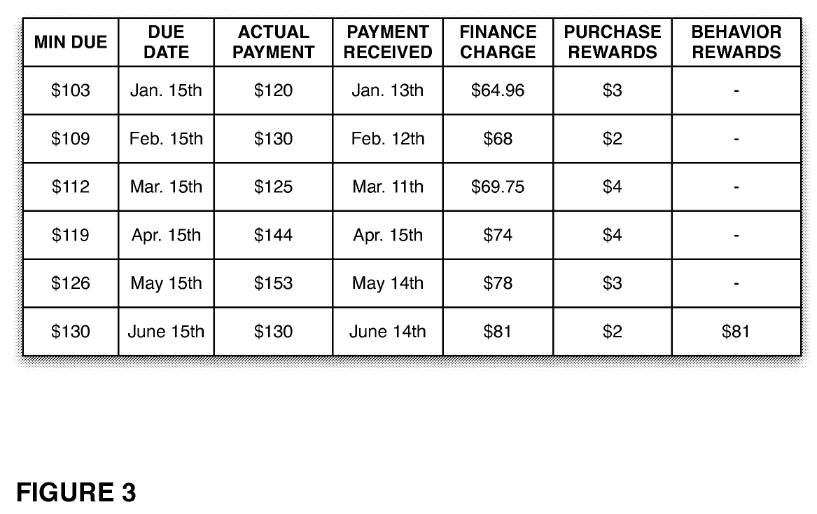

An exemplary application of the process of FIG. 2 is shown in FIG. 3. The cardholder has timely paid his account in an amount equal to at least the minimum payment due for the months of January through June. As a result, in June he receives rewards in the amount of a finance charge on his account statement that month, or $81. These rewards are in addition to any normal, purchase transaction-based rewards he may have earned for his purchases that month, such as the $2 for June. If the cardholder chooses to apply these rewards to his account, his finance charges that month may not capitalize into his outstanding balance. In one embodiment, the extra rewards are not available to be applied to the account until the following billing period (July).

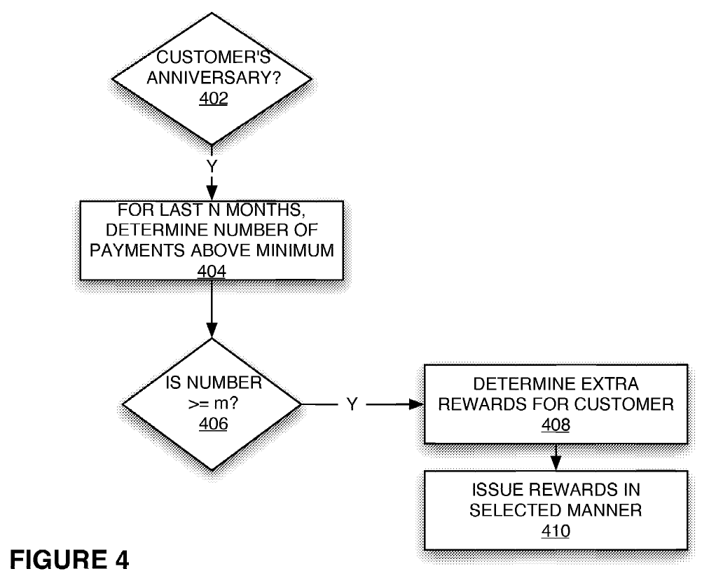

Turning to FIG. 4, a process is described for rewarding a credit card holder for making a number of payments in excess of the minimum payment due, in accordance with an embodiment of the invention. To ensure the rewards are awarded at most once each year, the process begins by checking at step 402 if it is the customer's designated anniversary of service with the card issuer. Alternatively, other timeframes may be used for which to check for reward-worthy behavior. If it is the cardholder's anniversary, then at step 404 payment activity is checked for the last N months to determine the number of payments made on the account that exceeded the amount of the minimum payment due, where N is a predetermined number set according to an issuer's rewards policy. In one embodiment, N is twelve. Alternatively, payment activity is checked to determine the number of payments made on the account that exceeded the minimum payment due by a predetermined amount or ratio (e.g., double). At step 406, the number of above-minimum payments is compared to a predetermined number m, where m is set by the issuer according to a rewards policy. In one embodiment, m is at least two. In one embodiment, m is three. If the number of above-minimum payments is at least m, then extra rewards are determined for the cardholder at step 408. In one embodiment, the amount of extra rewards is equivalent to the finance charges for that month. In another embodiment, the amount of extra rewards is a fixed amount. In this way, the cardholder can apply the extra rewards to his account balance and avoid having that month's finance charges capitalize. In one embodiment, the extra rewards are not available to be applied to the account until the following billing period.

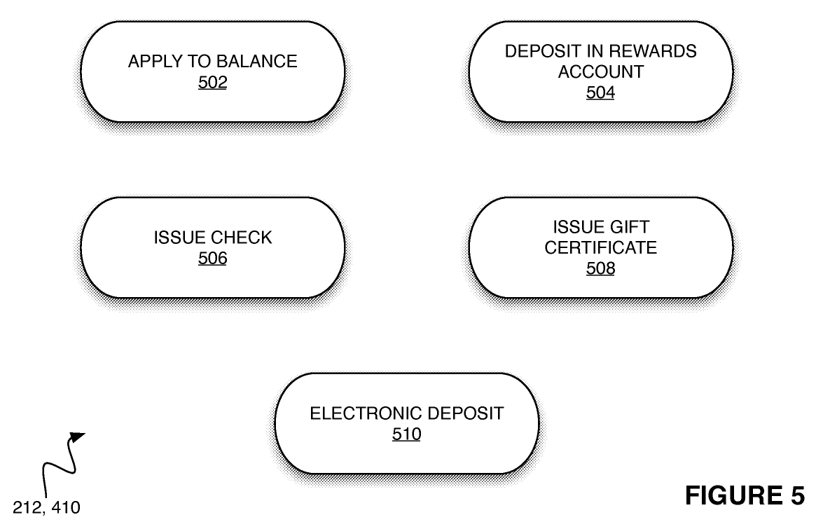

The rewards are issued at step 410 in any of a number of ways, as illustrated in FIG. 5. In embodiments of the invention, these ways include, but are not limited to, applying the rewards to the account as a payment 502, accumulating the rewards in the cardholder's rewards account 504, generating a check that is delivered to the cardholder 506, delivering a gift card or gift certificate to the cardholder that can be redeemed at a merchant 508, or making an electronic deposit to the cardholder bank account 510. In the last instance, the merchant may participate in a partner arrangement with the issuer so that the gift card or gift certificate is worth additional funds than the rewards earned by the cardholder (e.g., double value). The cardholder can select the manner of issuing rewards at that time, or he may previously have set up a default manner. Additionally, the issuer may issue the rewards in a default manner if the cardholder has not made any selection.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for providing rewards to a customer of a financial institution, the customer maintaining an account with the financial institution for a revolving line of credit, payments on the account due at about regular intervals in an amount of at least a minimum payment amount for each interval, the method comprising:
receiving a number of consecutive timely payments for consecutive intervals, each at least for the minimum amount due on the account;
determining that the number of consecutive timely payments is equal to or greater than a predetermined threshold greater than one; and
in response to the determining step, providing rewards to the customer.

2. The method of claim 1 wherein the predetermined threshold is at least three.

3. The method of claim 2 wherein the regular interval is about one month.

4. The method of claim 1 wherein the rewards are points or miles in an affinity program.

5. The method of claim 1 further comprising:
providing rewards to the customer for making purchases with the line of credit, wherein the amount of rewards is a function of the value of the purchases.

6. The method of claim 1 wherein the rewards are redeemable for cash with a redemption ratio of one reward to one dollar.

7. The method of claim 6 wherein a finance charge is due on the account, and the amount of rewards is the cash equivalent of the amount of the finance charge due on the account.

8. The method of claim 6 further comprising:
issuing the rewards in a manner selected from the group consisting of:
applying the rewards as a payment on the account;
accumulating the rewards in a separate account;
generating a check to the customer or electronic deposit; and
delivering to the customer a voucher redeemable for merchandise or services with a merchant.

9. A method for providing rewards to a customer of a financial institution, the customer maintaining an account with the financial institution for a revolving line of credit, payments on the account due at about regular periodic intervals in an amount of at least a minimum payment for each period, the method comprising:
receiving a number of payments within a predetermined timeframe, each of the payments being of a value equal to or exceeding the minimum amount due for the corresponding period;
determining that the number of payments equal to or exceeding the minimum amount due is equal to or greater than a predetermined threshold greater than one; and
in response to the determining step, providing rewards to the customer.

10. The method of claim 9 wherein the predetermined timeframe is about one year, and wherein the predetermined threshold is at least two.

11. The method of claim 9 wherein the rewards are points or miles in an affinity program.

12. The method of claim 9 wherein the rewards are equivalent to cash.

13. The method of claim 12 further comprising:
issuing the rewards in a manner selected from the group consisting of:
applying the rewards as a payment on the account;
accumulating the rewards in a separate account;
generating a check to the customer or electronic deposit; and
delivering to the customer a voucher redeemable for merchandise or services with a merchant.

14. A system for providing rewards to a customer of a financial institution, the system comprising:
a billing module for preparing a billing statement at a substantially regular periodic interval to be sent to a customer of the financial institution, the customer maintaining an account with the financial institution for a line of credit, and the statement indicating the status of the account; and
a payment-based rewards determination module for determining that the customer has satisfied one or more predetermined payment criteria, and for determining the number of rewards to be rewarded to the customer for satisfying the one or more predetermined payment criteria.

15. The system of claim 14 wherein the one or more predetermined payment criteria comprises a predetermined number of consecutive timely payments to the customer's account.

16. The system of claim 15 wherein the predetermined number is at least three.

17. The system of claim 14 wherein the one or more predetermined payment criteria comprises at least a predetermined number of payments to the customer's account within a predetermined timeframe, each of the predetermined number of payments being of a value exceeding the minimum amount due on the account for the corresponding period.

18. The system of claim 17 wherein the predetermined timeframe is about one year, and wherein the predetermined number of payments is at least two.

19. The system of claim 14 wherein the one or more predetermined payment criteria consist of information regarding payments made to the customer's account.

20. The system of claim 14 further comprising a purchase-based rewards determination module for determining the number of rewards to be rewarded for each purchase made by the customer.
